(19) United States
(12) Patent Application Publication
(10) Pub. No.: US 2014/0197569 A1
(43) Pub. Date: Jul. 17, 2014

(54) METHOD OF FABRICATING A HOLE IN A COMPOSITE PANEL

(71) Applicant: GM GLOBAL TECHNOLOGY OPERATIONS LLC, Detroit, MI (US)

(72) Inventors: Joseph M. Polewarczyk, Rochester Hills, MI (US); Paul E. Krajewski, Troy, MI (US)

(73) Assignee: GM GLOBAL TECHNOLOGY OPERATIONS LLC, Detroit, MI (US)

(21) Appl. No.: 13/741,418

(22) Filed: Jan. 15, 2013

(51) Int. Cl. B29C 67/00

(52) U.S. Cl. CPC B29C 67/0048
USPC 264/258

(57) ABSTRACT

A method of forming a hole in a composite panel includes positioning a first fiber sheet on a layup table, where the layup table has a forming tool extending outward from a portion of the table, and the fiber sheet includes a plurality of fibers oriented along a first common direction. The method further includes extending the forming tool through the first fiber sheet such that a subset of the plurality of fibers are displaced about the forming tool: applying a resin to the sheet of fibers; pre-curing the resin to form a pre-preg part defining a hole about the forming tool; and removing the pre-preg part from the layup table.

### TECHNICAL FIELD

The present invention relates generally to composite part forming techniques.

### BACKGROUND

Composite materials are typically formed by embedding a high-tensile strength fibrous material within a epoxy/resin matrix which is then solidified or polymerized to create the composite. An intermediate forming step to the final creation of the composite material often involves creating a pre-preg composite part. Pre-preg is a term for “pre-impregnated” composite fibres where a material, such as epoxy is already present. These usually take the form of a weave or are uni-directional. The pre-preg already contains an amount of the matrix material used to bond the fibers together. The resin, however is only partially cured to allow easy handling.

Carbon-fiber composite is an example of one composite material that is used in manufacturing applications. It is favored for its high strength and light weight properties. Typical carbon-fiber part forming techniques involve forming a rough part in an initial step, and machining necessary features into the rough part (via material removal) in a subsequent step. Examples of subsequent machining may include drilling holes, planning surfaces, and milling cavities (e.g., between stiffening ribs). These machining processes, however, may sever integral fibers and compromise the integrity and/or strength of the finished part.

### SUMMARY

A method of forming a hole in a composite panel includes positioning a first fiber sheet on a layup table, where the layup table has a forming tool extending outward from a portion of the table, and the fiber sheet includes a plurality of fibers oriented along a first common direction. The method further includes extending the forming tool through the first fiber sheet such that a subset of the plurality of fibers are displaced about the forming tool: applying a resin to the sheet of fibers; pre-curing the resin to form a pre-preg part defining a hole about the forming tool; and removing the pre-preg part from the layup table. In one configuration, the fibers may be carbon fibers.

Additionally, a second fiber sheet may be positioned on the layup table prior to applying the resin, the second fiber sheet may similarly include a second plurality of fibers oriented along a second common direction. The forming tool may be extended through the second fiber sheet such that a subset of the second plurality of fibers are displaced about the forming tool. In one configuration, the method may further include: inserting the pre-preg part into a part mold; and curing the pre-preg part within the part mold.

The forming tool may include at least one of a conical portion and a pyramidal portion, wherein the at least one of a conical portion and a pyramidal portion is configured to pierce through the first fiber sheet. The forming tool may further include a cylindrical portion between the layup table and the at least one of a conical portion and a pyramidal portion.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a flow diagram illustrating a method of forming a hole in a composite panel.

FIG. 2 is a schematic perspective view of a layup table having a forming tool, and a fiber sheet disposed above the layup table.

FIG. 3 is a schematic perspective view of the layup table of FIG. 2, with the fiber sheet disposed on the layup table.

FIG. 4 is a schematic perspective view of the layup table of FIG. 3 with a resin applied to the fiber sheet.

FIG. 5 is a schematic perspective view of a pre-impregnated composite part, such as made from the assembly of FIG. 4.

FIG. 6 is a schematic perspective view of the layup table of FIG. 2, with a plurality of fiber sheets disposed on the layup table.

### DETAILED DESCRIPTION

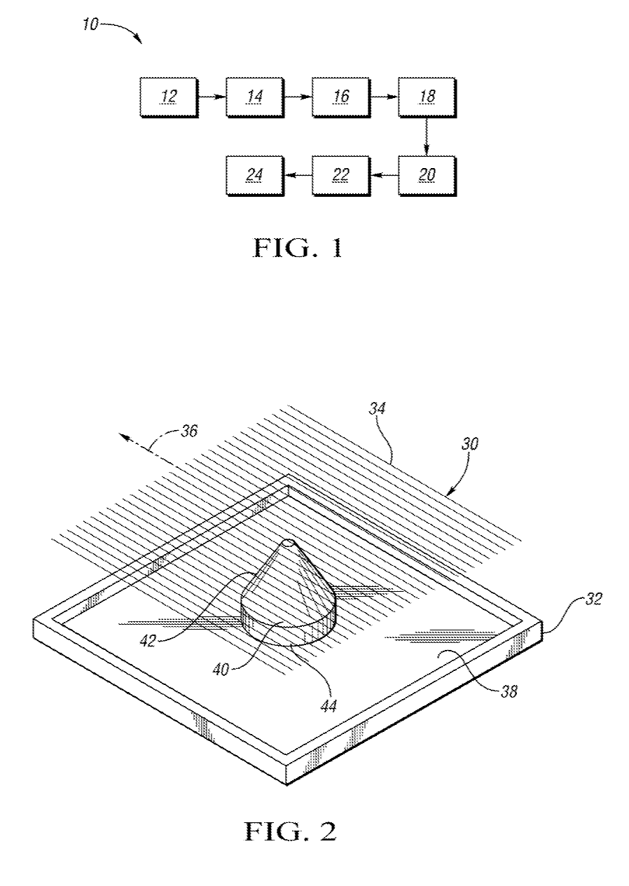

Referring to the drawings, wherein like reference numerals are used to identify like or identical components in the various views, FIG. 1 schematically illustrates a method 10 of forming a hole in a composite panel. The method 10 begins at step 12 when a fiber sheet 30 is positioned on a layup table 32, as shown in FIG. 2. The fiber sheet 30 may be formed from a plurality of individual fibers 34 that may include spun glass fibers, carbon fibers, graphite fibers or other suitable high-tensile strength fiber materials. In one configuration, each individual fiber may have a thickness/diameter of approximately 5-10 μm. In other configurations, however, fibers having larger or smaller thicknesses may likewise be used.

The fiber sheet 30 may generally be a thin sheet of fiber-based fabric where numerous fibers are oriented within a single plane, or within approximately 1-2 mm of a common plane. In one configuration, the fiber sheet may include a plurality of fibers 34 that are longitudinally aligned in a common direction 36. For example, the fiber sheet 30 may be a unidirectional array of fibers, such that substantially all of the fibers are oriented along the common direction 36. Alternatively, the fiber sheet 30 may be a woven fabric sheet where a plurality of the fibers 34 are oriented along the common direction 36, though other fibers may be oriented along a different direction, such as perpendicular to the common direction 36.

The layup table 32 may be a solid, planar table that may be used to form a pre-impregnated composite part, also referred to as a pre-preg part or simply a pre-preg. The layup table 32 may include a recessed cavity 38 in the rough shape of a desired final composite part. In very general terms, the pre-preg part may be a “blank” that may be used in subsequent molding processes to form a part with more complex geometry. In this manner, multiple pre-preg “blanks” may be molded together into a complex geometry wherein a final curing process may fuse the pre-pregs together in a final form.

The layup table 32 may include a forming tool 40 extending outward from a portion of the table 32 within the recessed cavity 38 that may be used to integrally form a hole within the final part. The forming tool 40 may include a conical or pyramidal portion 42 and a cylindrical portion 44, with the cylindrical portion 44 being disposed between the conical or pyramidal portion 42 and the table 32. The hole created by the forming tool 40 may be used to structurally mount the composite panel to another component in a final assembly process. For example, in one application, the final composite panel may be used as a body panel for an automotive vehicle. During final vehicle assembly, the hole that is created by the forming tool 40 may be used to rivet or otherwise fasten the panel to a frame member of the vehicle.

Referring again to FIG. 1, after the fiber sheet 30 is positioned on the layup table 32 in step 12, the forming tool 40 may be extended through the fiber sheet 30 in step 14 such that a subset of the plurality of fibers 34 are displaced about the forming tool 38. The conical/pyramidal portion 42 of the forming tool 40 may include a sharp enough point on its distal end to wedge between individual fibers without intentionally cutting or severing the respective fibers. As the forming tool 40 is extended through the plurality of fibers 34, the gradually increasing width of the conical/pyramidal portion 42 may separate the fibers such that they are displaced around the tool 40, and eventually where the cylindrical portion 40 may extend between the separated fibers, as shown in FIG. 3.

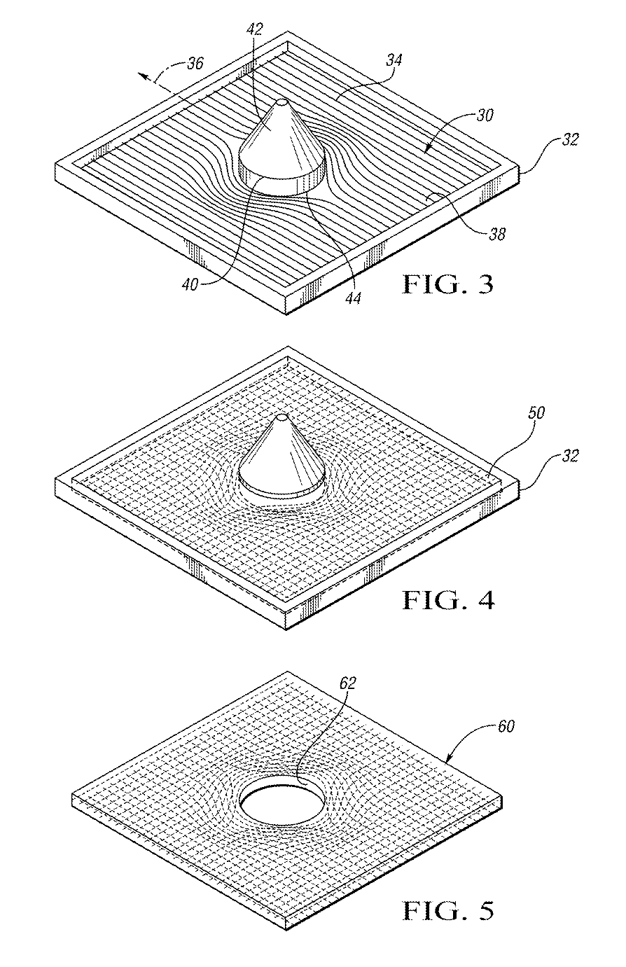

After the fiber sheet 30 is positioned on the layup table 32 with the forming tool 40 extending through the plurality of fibers 34, in step 16 (FIG. 1) an epoxy/resin 50 may be applied to the sheet of fibers 30 within the recessed cavity 38. The resin 50 may flow between the fibers, as generally shown in FIG. 4, where it may be partially cured or pre-cured in step 18 to firm the resin about the fibers and form the pre-preg part. In this state, the fibers may be suspended within the resin matrix and the resin matrix may be solidified to a point where it may be handled. The pre-curing process may involve, for example, heating the resin/epoxy to a temperature lower than a final curing temperature, though above ambient. For example, with a resin that may be finally cured at 300 degrees Celsius, the pre-curing may take place by heating the resin to 100 degrees Celsius, and potentially for a shorter duration of time.

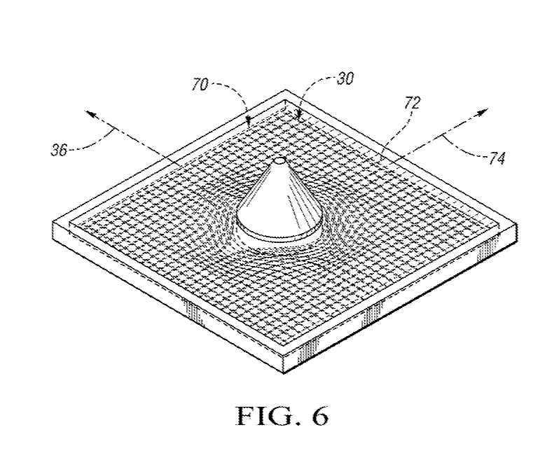

Once the pre-preg part is sufficiently pre-cured to allow it to be handled without a loss of structural integrity or further flowing of the resin 50 while at room temperature, it may be removed from the layup table 32 (step 20). In this manner, as shown in FIG. 5, the pre-preg part 60 may define a hole 62 that is integrally fabricated within the composite. As such, the plurality of fibers 34 may be disposed about the hole without being severed at the hole 62. This method of manufacture/part fabrication is in stark contrast to other methods of fabrication, where holes or other surface features are cut, milled, drilled, or otherwise machined into a cured part. With those post-processing techniques, the fibers are generally severed, which may adversely affect the structural integrity of the part.

After the initial forming of the pre-preg part 60 in steps 12 through 20, the pre-preg part 60 may be inserted in a final mold (step 22), for example, with one or more other pre-preg parts 60, whereafter the collection of pre-preg parts may be finally cured through the application of heat and/or temperature (step 24).

In an extension of this methodology, prior to the application of the resin in step 16, one or more additional fiber sheets may be layered over the initially placed fiber sheet 30. For example, as generally illustrated in FIG. 6, a second fiber sheet 70 may be placed above the first fiber sheet 30. The second fiber sheet 70 may be similar in construction as compared to the first fiber sheet 30, with a plurality of fibers 72 substantially oriented along a second common direction 74. When placed on the layup table 32, the second fiber sheet 70 may be oriented such that the second common direction 74 is not parallel with the direction 36 of the fibers 34 in the first sheet 30 (i.e., the first common direction 36). In this manner, the fibers 72 of the second sheet 70 may provide strength/rigidity in an additional plane. For example, the first fiber sheet 30 and second fiber sheet 70 may be oriented such that their respective fibers are perpendicular to each other. In yet another configuration, a plurality of fiber sheets may be positioned on the layup table 32, with each successive sheet being offset from the previous by a predetermined angular offset. For example, 24 fiber sheets may be individually positioned such that each sheet is rotated by 15 degrees from the previously laid sheet.

In the example described with respect to FIG. 6, if a plurality of sheets are positioned on the layup table 32, the forming tool 40 may extend through each respective sheet, such that the fibers of that sheet are displaced about the tool 40.

The present methods are equally applicable to both thermoset and thermoplastic composite materials, and absent specific statements to the contrary, nothing described herein should be read to limit the nature of the substrate.

While the best modes for carrying out the invention have been described in detail, those familiar with the art to which this invention relates will recognize various alternative designs and embodiments for practicing the invention within the scope of the appended claims. It is intended that all matter contained in the above description or shown in the accompanying drawings shall be interpreted as illustrative only and not as limiting.

1. A method of forming a hole in a composite panel comprising:
positioning a first fiber sheet on a layup table, the layup table having a forming tool extending outward from a portion of the table, the fiber sheet including a plurality of fibers oriented along a first common direction;
extending the forming tool through the first fiber sheet such that a subset of the plurality of fibers are displaced about the forming tool;
applying a resin to the sheet of fibers;
pre-curing the resin to form a pre-preg part defining a hole about the forming tool; and
removing the pre-preg part from the layup table.

2. The method of claim 1, further comprising:
inserting the pre-preg part into a part mold;
curing the pre-preg part within the part mold.

3. The method of claim 2, wherein curing the pre-preg part within the part mold includes heating and applying pressure to the pre-preg part.

4. The method of claim 1, further comprising:
positioning a second fiber sheet on the layup table prior to applying the resin, the second fiber sheet including a second plurality of fibers oriented along a second common direction; and
extending the forming tool through the second fiber sheet such that a subset of the second plurality of fibers are displaced about the forming tool.

5. The method of claim 4, wherein the first common direction is not parallel to the second common direction.

6. The method of claim 1, wherein the forming tool includes at least one of a conical portion and a pyramidal portion, and wherein the at least one of a conical portion and a pyramidal portion is configured to pierce through the first fiber sheet.

7. The method of claim 6, wherein the forming tool includes a cylindrical portion between the layup table and the at least one of a conical portion and a pyramidal portion.

8. The method of claim 1, wherein the removed pre-preg part defines a hole formed by the forming tool.

9. The method of claim 1, wherein the step of extending the forming tool through the first sheet of fibers is characterized by not severing any of the plurality of fibers.

10. A method of forming a hole in a carbon fiber composite panel comprising:
positioning a first carbon fiber sheet on a layup table, the layup table having a forming tool extending outward from a portion of the table, the first carbon fiber sheet including a plurality of carbon fibers oriented along a first common direction;
positioning a second carbon fiber sheet on the layup table prior to applying the resin, the second carbon fiber sheet including a second plurality of carbon fibers oriented along a second common direction; and
extending the forming tool through the first carbon fiber sheet and the second carbon fiber sheet such that a subset of each of the first plurality of carbon fibers and the second plurality of carbon fibers are displaced about the forming tool;
applying a resin to the first and second carbon fiber sheet;
pre-curing the resin to form a carbon fiber pre-preg part defining a hole about the forming tool; and
removing the carbon fiber pre-preg part from the layup table.

11. The method of claim 10, further comprising:
inserting the carbon fiber pre-preg part into a part mold;
curing the carbon fiber pre-preg part within the part mold.

12. The method of claim 11, wherein curing the carbon fiber pre-preg part within the part mold includes heating and applying pressure to the carbon fiber pre-preg part.

13. The method of claim 10, wherein the first common direction is not parallel to the second common direction.

14. The method of claim 10, wherein the forming tool includes at least one of a conical portion and a pyramidal portion, and wherein the at least one of a conical portion and a pyramidal portion is configured to pierce through the first carbon fiber sheet and the second carbon fiber sheet.

15. The method of claim 14, wherein the forming tool includes a cylindrical portion between the layup table and the at least one of a conical portion and a pyramidal portion.

16. The method of claim 10, wherein the removed carbon fiber pre-preg part defines a hole formed by the forming tool.

17. The method of claim 1, wherein the step of extending the forming tool through the first and second sheet of fibers is characterized by not severing any of the first and second plurality of carbon fibers.
